(19) United States
(12) Patent Application Publication
(10) Pub. No.: US 2025/0086491 A1
(43) Pub. Date: Mar. 13, 2025

(54) VARIATIONAL QUANTUM SELF-ORGANIZING MAP

(71) Applicant: International Business Machines Corporation, Armonk, NY (US)

(72) Inventor: Amol Deshmukh, New York, NY (US)

(21) Appl. No.: 18/465,373

(22) Filed: Sep. 12, 2023

(51) Int. Cl. G06N 10/60

(52) U.S. Cl. CPC G06N 10/60

(57) ABSTRACT

Systems, computer program products and/or computer-implemented methods described herein relate to generating and using a self-organizing map based on a quantum kernel approach. A system can comprise a memory that stores computer executable components and a processor that executes the computer executable components, which can comprise an estimating component that executes a set of quantum circuits at a quantum processor resulting in measured outputs defining estimated inner products between a sample quantum state, of a set of quantum data, and a set of weight vectors, associated with neurons of a lattice space of a neural network, and a determining component that, based on the estimated inner products, identifies a best matching neuron of the lattice space having a closest distance, of the neurons of the lattice space, to the sample quantum state within a Hilbert space, comprising the set of quantum data and the lattice space, of the neural network.

### TECHNICAL FIELD

The present disclosure relates to generating a self-organizing map based on a quantum kernel approach at a neural network and using the self-organizing map to infer results.

### BACKGROUND

Learning by a competitive-learning neural network (NN) can be by way of competition and reward functions. Neurons in an output layer of such NN can receive input information from a respective input layer. During training of the NN, interactions among the neurons can take place, with one neuron can be identified as a winner and activities of the other neurons in the output layer being supressed. The winner neurons can alternate and can be dependent on the received input. Once trained, different sections of the NN can become sensitive to different parts of vectorial input signals.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide a process to train and employ artificial intelligence, such as a neural network (NN), by facilitating the learning by the NN of a mapping form a higher dimensional Hilbert space to a lower-dimensional grid of lattice points of a Hilbert space of the NN, and thus training the NN as a self-organizing map (SOM).

In accordance with an embodiment, a system can comprise a memory that stores computer executable components and a processor that executes the computer executable components stored in the memory. The computer executable components comprise an estimating component that executes a set of quantum circuits at a quantum processor resulting in measured outputs defining estimated inner products between a sample quantum state, of a set of quantum data, and a set of weight vectors, associated with neurons of a lattice space of a neural network, and a determining component that, based on the estimated inner products, identifies a best matching neuron of the lattice space having a closest distance, of the neurons of the lattice space, to the sample quantum state within a Hilbert space of the neural network, the Hilbert space comprising the set of quantum data and the lattice space.

In accordance with another embodiment, a computer-implemented method can comprise executing, by a system operatively coupled to a processor, a set of quantum circuits at a quantum processor resulting in measured outputs defining estimated inner products between a sample quantum state, of a set of quantum data, and a set of weight vectors, associated with neurons of a lattice space of a neural network, and based on the estimated inner products, identifying, by the system, a best matching neuron of the lattice space having a closest distance, of the neurons of the lattice space, to the sample quantum state within a Hilbert space of the neural network, the Hilbert space comprising the set of quantum data and the lattice space.

In accordance with still another embodiment, a computer program product, facilitating a process for promoting green energy practices for terrace slope farming, can comprise a computer readable storage medium having program instructions embodied therewith, the program instructions executable by a processor to cause the processor to execute, by the processor, a set of quantum circuits at a quantum processor resulting in measured outputs defining estimated inner products between a sample quantum state, of a set of quantum data, and a set of weight vectors, associated with neurons of a lattice space of a neural network, and based on the estimated inner products, identify, by the processor, a best matching neuron of the lattice space having a closest distance, of the neurons of the lattice space, to the sample quantum state within a Hilbert space of the neural network, the Hilbert space comprising the set of quantum data and the lattice space.

### DESCRIPTION OF THE DRAWINGS

FIG. 1 illustrates a block diagram of an example, non-limiting system that can provide a process to train and employ a variational quantum self-organizing map, in accordance with one or more embodiments described herein.

FIG. 2 illustrates a block diagram of another example, non-limiting system that can provide a process to train and employ a variational quantum self-organizing map, in accordance with one or more embodiments described herein.

FIG. 3 provides an illustration of a neural network as trained and employed by the non-limiting system of FIG. 2, in accordance with one or more embodiments described herein.

FIG. 4 illustrates a non-limiting quantum system that can be employed by the non-limiting system of FIG. 2 to train a neural network, in accordance with one or more embodiments described herein.

FIG. 5 illustrates a visualization of various processes that can be performed by a SOM based on direction by the non-limiting system of FIG. 2, in accordance with one or more embodiments described herein.

FIG. 6A illustrates a diagrammatic view of a quantum circuit that can be employed to estimate a transition probability by the non-limiting system of FIG. 2, in accordance with one or more embodiments described herein.

FIG. 6B illustrates a diagrammatic view of another quantum circuit that can be employed to estimate a transition probability between an unknown quantum state and variational ansatz by the non-limiting system of FIG. 2, in accordance with one or more embodiments described herein.

FIG. 7 illustrates a flow diagram of one or more processes that can be performed by the non-limiting system of FIG. 2, in accordance with one or more embodiments described herein.

FIG. 8 illustrates a flow diagram of one or more processes that can be performed by the non-limiting system of FIG. 2, in accordance with one or more embodiments described herein.

FIG. 9 illustrates a continuation of the flow diagram of FIG. 8 of one or more processes that can be performed by the non-limiting system of FIG. 2, in accordance with one or more embodiments described herein.

FIG. 10 illustrates a block diagram of example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A self-organizing map (SOM) is a particular type of competitive-learning NNs. A SOM can be conceived as a two-layered feedforward NN with all-to-all connections from an input layer of input data to neurons in an output layer of results. SOMs can be employed as tools for unsupervised machine learning tasks such as clustering, dimensionality reduction and construction of low-dimensional topology preserving visualizations of high-dimensional datasets in a wide range of fields, such as finance, natural language processing, sociology, biology, etc.

Typically, training SOMs on large datasets can be a time-consuming and costly process in terms of labor, money, power, computing power, etc. Indeed, where the training data has a sufficiently complicated structure, SOMs can be unable to uncover a hidden structure thereof within the training datasets. Use of improved efficiency algorithms and/or hardware accelerators, such as graphics processing units (GPUs), to expedite the training of SOMs does not provide sufficient acceleration when faced with sufficiently structurally-complicated datasets.

To account for one or more of these deficiencies of existing frameworks (e.g., agricultural data analytics processes), one or more embodiments are described herein that can employ a quantum processor for unsupervised learning of quantum data by a quantum neural network, using a quantum kernel-based approach. These one or more embodiments can result in a novel training methodology that can train a NN as a SOM more efficiently and more rapidly that existing approaches, and which can train a NN on sufficiently structurally-complicated datasets on which NNs/SOMs have been unable to be trained using existing approaches. As a result of the one or more embodiments described herein, a NN can be trained as a SOM by learning a mapping form a higher dimensional Hilbert space to a lower-dimensional grid of lattice points of a Hilbert space of the NN.

As used herein the term “SOM” can refer to a neural network. For example, the term “neural network” can refer to the neural network prior to the training, resulting in a trained SOM, which is also a type of competitively-trained neural network.

More particularly, the one or more embodiments described herein can, employing a NN, map a set of quantum data to a Hilbert space using quantum feature mapping, initialize a set of variational parameters (e.g., weights) at the Hilbert space, estimate fidelities between input and output layers of the Hilbert space, adjust a feature space of the output layer of the Hilbert space based on the estimated fidelities, and perform inference of additional quantum data upon having trained a NN as a SOM.

By employing the power of a quantum processor, the one or more embodiments described herein can process exceedingly complicated data structures to thereby train the NN as existing approaches have failed to do. That is, by generating quantum circuits representing calculations for inner products between the inner and outer layers of the Hilbert space, directing execution of the quantum circuits on the quantum processor, and obtaining measurement readouts from the quantum processor, the one or more embodiments described herein can facilitate previously unattainable training of a NN to a SOM, and/or can facilitate such training with previously unattainable efficiency, accuracy and/or timing.

Furthermore, the training can be completed in a way that can preserve topology of an initially-prepared lattice of neurons of the NN while learning a mapping of a high-dimensional Hilbert space to a low-dimensional lattice grid at the initially-prepared lattice.

Put another way, the one or more embodiments described herein can provide for variational hybrid (e.g., classical and quantum) unsupervised learning that can be built-in for algorithms, models and/or products providing unsupervised learning tasks such as clustering, dimensionality reduction and/or construction of low-dimensional topology preserving lattices. Accordingly, such embodiments can be used for classifying various phases of chemicals and analyzing properties of various condensed matter systems, enhancing financial predictions, and/or enhancing predictive capabilities of drug design, chemical design, material sciences and/or high-energy physics, without being limited thereto.

As used herein, the term “data” can comprise metadata.

As used herein, the terms “entity,” “requesting entity.” and “user entity” can refer to a machine, device, component, hardware, software, smart device, party, organization, individual and/or human.

### DESCRIPTION

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

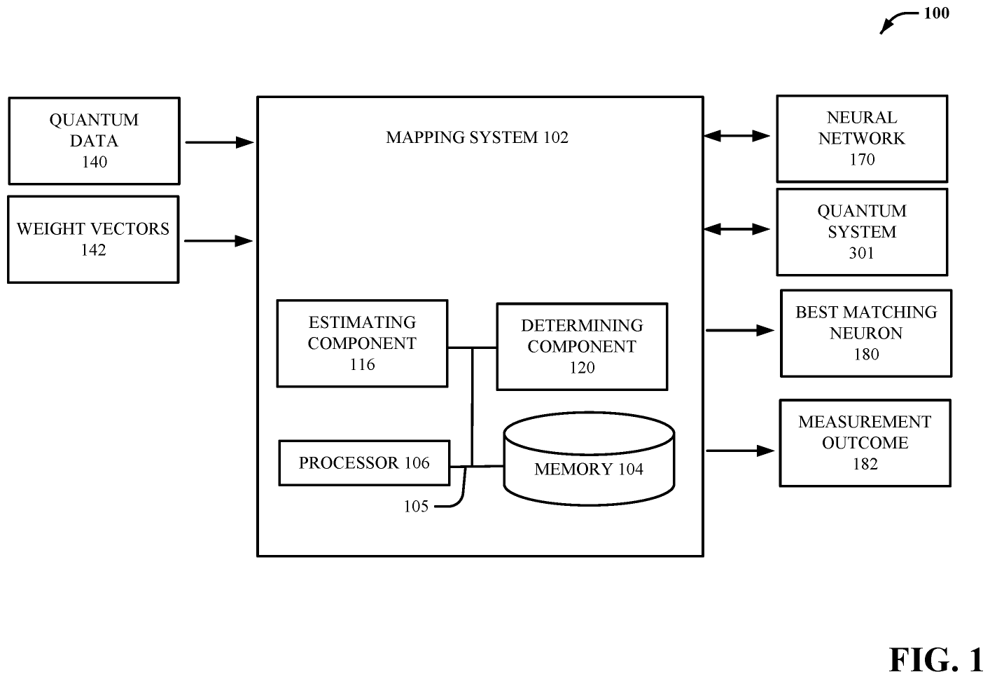

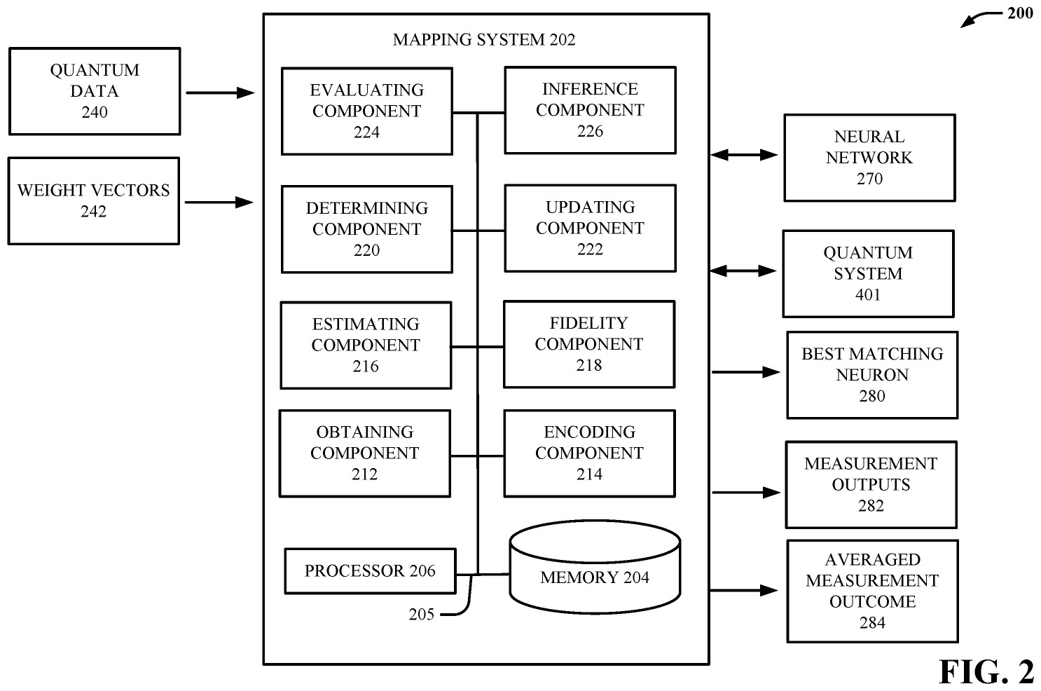

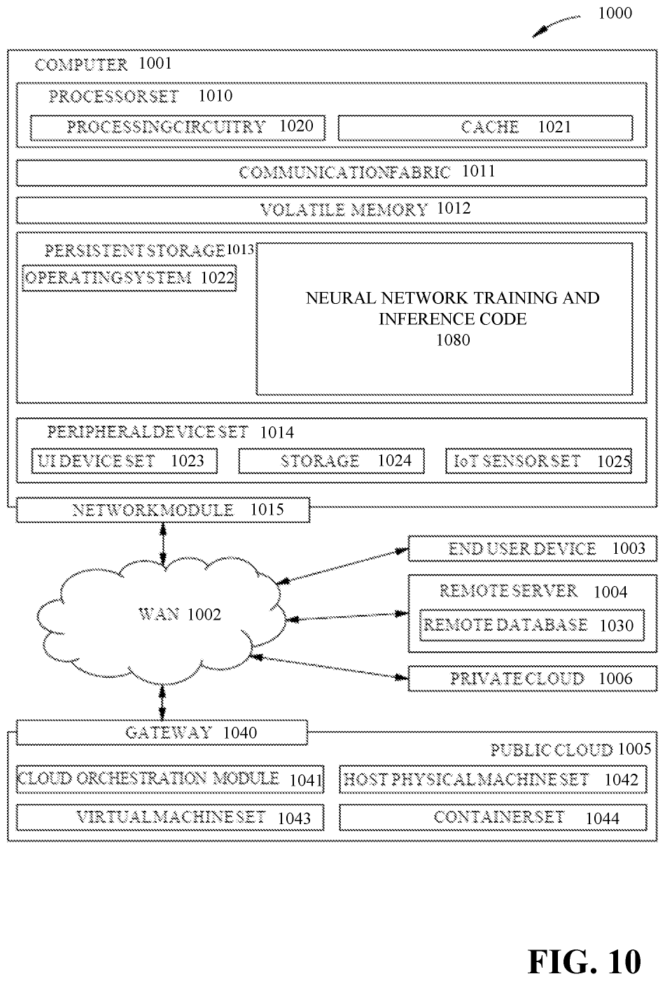

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIGS. 1 and/or 2 and/or with other figures described herein.

Turning now in particular to one or more figures, and first to FIG. 1, the figure illustrates a block diagram of an example, non-limiting system 100 that can facilitate a process to train a variational quantum self-organizing map, in accordance with one or more embodiments described herein. That is, the non-limiting system 100 can facilitate a process to train a neural network (NN) as a self-organizing map (SOM), and in particular, as a variational quantum SOM (variational QSOM).

The non-limiting system 100 comprises a mapping system 102. It is noted that the mapping system 102 is only briefly detailed to provide but a lead-in to a more complex and/or more expansive mapping system 202 as illustrated at FIG. 2. That is, further detail regarding processes that can be performed by one or more embodiments described herein will be provided below relative to the non-limiting system 200 of FIG. 2.

Still referring to FIG. 1, the mapping system 102 can comprise at least a memory 104, bus 105, processor 106, estimating component 116 and determining component 120. Using these components, the mapping system 102 can train a neural network 170, using a quantum system 401 to enable the neural network 170 to learn a mapping form a higher-dimensional set of quantum data, such as a higher-dimensional Hilbert space, to a lower-dimensional grid of lattice points, while preserving the underlying topology of the Hilbert space. This learning of the neural network 170 can comprise inputting a set of quantum data 140, a set of variational parameters (e.g., weight vectors 142) and a set of variational parameter updates based on quantum kernels and associated kernel functions.

The estimating component 116 generally can execute a set of quantum circuits at a quantum processor resulting in measured outputs defining estimated inner products between a sample quantum state, of a set of quantum data 140, and a set of variational parameters (e.g., a set of weight vectors 142), associated with neurons of a lattice space of a neural network 170. That is, the estimating component 116 can execute the set of quantum circuits by sending, or otherwise making available, the set of quantum circuits to the quantum processor, such as of the quantum system 401. The quantum system 401 can operate the quantum processor on a set of one or more qubits, with measurement outputs defining one or more changes to the qubits representing the estimated inner products. Subsequently, based on the measurement readouts from the quantum processor, the estimated inner products can be determined by the estimating component.

The set of quantum circuits can represent the calculations for determining the inner products between the single sample quantum state and each of the weight vectors of the set of weight vectors 142. To further train the neural network 170, additional sets of quantum circuits, representing calculations for determining the inner products between all other single quantum states of the set of quantum data 140 and each of the weight vectors of the set of weight vectors 142, also can be executed by the estimating component 116.

It is noted that while the estimating component 116 can operate at a classical system comprising the mapping system 102, the classical system, by way of the estimating component 116, can employ the quantum system 401 to obtain the measurement readouts representing the estimated inner products. One or more additional classical processes can be performed, such as by the estimating component 116 to determine the estimated inner products from the measurement readouts.

The determining component 120 generally can, based on the estimated inner products, identifies a best matching neuron of the lattice space having a closest distance, of the neurons of the lattice space, to the sample quantum state within a Hilbert space of the neural network 170, the Hilbert space comprising the set of quantum data 140 and the lattice space. That is, the determining component 120 can compare results based on the estimated inner products (e.g., fidelities between the sample quantum states and quantum states representing the variational parameters) to determine a best matching neuron 180 for each sample quantum state. Each best matching neuron 180 can be a neuron of an output layer of the neural network 170 that is closest, within the Hilbert space defined by the neural network 170 and comprising an input layer of neurons corresponding to the sample quantum states and the output layer (e.g., lattice space) of neurons corresponding to the quantum states representing the variational parameters, to the neuron of the input layer that corresponds to the sample quantum state being analyzed of the sample quantum states.

The estimating component 116 and the determining component 120 can be operatively coupled to a processor 106 which can be operatively coupled to a memory 104. The bus 105 can provide for the operative coupling. The processor 106 can facilitate execution of the estimating component 116 and the determining component 120. The estimating component 116 and the determining component 120 can be stored at the memory 104.

In general, the non-limiting system 100 can employ any suitable method of communication (e.g., electronic, communicative, internet, infrared, fiber, etc.) to provide communication between the mapping system 102, the neural network 170 and the quantum system 401.

Turning next to FIG. 2, a non-limiting system 200 is illustrated that can comprise a mapping system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the mapping system 202 can facilitate a process to train a variational quantum self-organizing map, in accordance with one or more embodiments described herein. That is, the non-limiting system 100 can facilitate a process to train a neural network (NN) as a self-organizing map (SOM), and in particular, as a variational quantum SOM (variational QSOM). The mapping system 202 also can facilitate a process to employ the trained variational QSOM to perform inferences relative to additional input data samples to the mapping system 202.

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The mapping system 202 can be associated with, such as accessible via, a cloud computing environment.

The mapping system 202 can comprise a plurality of components. The components can comprise a memory 204, processor 206, bus 205, obtaining component 212, encoding component 214, estimating component 216, fidelity component 218, determining component 220, updating component 222, evaluating component 224 and inference component 226. Using these components, the mapping system 202 can perform the training, and subsequent use of, a neural network 270 into a variational QSOM having learned a mapping from a higher-dimensional Hilbert space, to a lower-dimensional grid of lattice points, while preserving the underlying topology of the Hilbert space.

Discussion next turns briefly to the processor 206, memory 204 and bus 205 of the mapping system 202. For example, in one or more embodiments, the mapping system 202 can comprise the processor 206 (e.g., computer processing unit, microprocessor, classical processor, quantum processor and/or like processor). In one or more embodiments, a component associated with mapping system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the obtaining component 212, encoding component 214, estimating component 216, fidelity component 218, determining component 220, updating component 222, evaluating component 224 and inference component 226.

In one or more embodiments, the mapping system 202 can comprise the computer-readable memory 204 that can be operably connected to the processor 206. The memory 204 can store computer-executable instructions that, upon execution by the processor 206, can cause the processor 206 and/or one or more other components of the mapping system 202 (e.g., obtaining component 212, encoding component 214, estimating component 216, fidelity component 218, determining component 220, updating component 222, evaluating component 224 and inference component 226) to perform one or more actions. In one or more embodiments, the memory 204 can store computer-executable components (e.g., obtaining component 212, encoding component 214, estimating component 216, fidelity component 218, determining component 220, updating component 222, evaluating component 224 and inference component 226).

The mapping system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the mapping system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the mapping system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the mapping system 202, the neural network 270 and the quantum system 401.

In addition to the processor 206 and/or memory 204 described above, the mapping system 202 can comprise one or more computer and/or machine readable, writable and/or executable components and/or instructions that, when executed by processor 206, can provide performance of one or more operations defined by such component and/or instruction.

Turning now to the additional components of the mapping system 202 (e.g., obtaining component 212, encoding component 214, estimating component 216, fidelity component 218, determining component 220, updating component 222, evaluating component 224 and inference component 226), generally, the mapping system 202 can generate and/or train the neural network 270 to a variational QSOM or as a variational QSOM, which can then be employed by the mapping system 202 to output one or more estimations in response to a query.

Turning first to the obtaining component 212, the obtaining component 212 can generally identify, search, receive, transfer and/or otherwise obtain input data from one or more databases, online resources, entities and/or information caches. The input information can comprise a query 260, set of quantum data 240 and/or set of variational parameters, such as a set of weight vectors 242. This input data can be made available to and/or transmitted to the other components of the mapping system 202 (e.g., the encoding component 214, estimating component 216, etc.)

The set of quantum data 240 can be obtained from classical data, quantum simulation, quantum transducers, etc. The set of quantum data 240 can result from and/or be based on output of the quantum system 401 or of another quantum system. For example, the mapping system 202 can be employed to allow the NN 270 to learn the topological structure of quantum data generated by quantum simulations of quantum materials by the quantum system 401. In one or more embodiments, classical data can be transformed into quantum data, such as one or more quantum states.

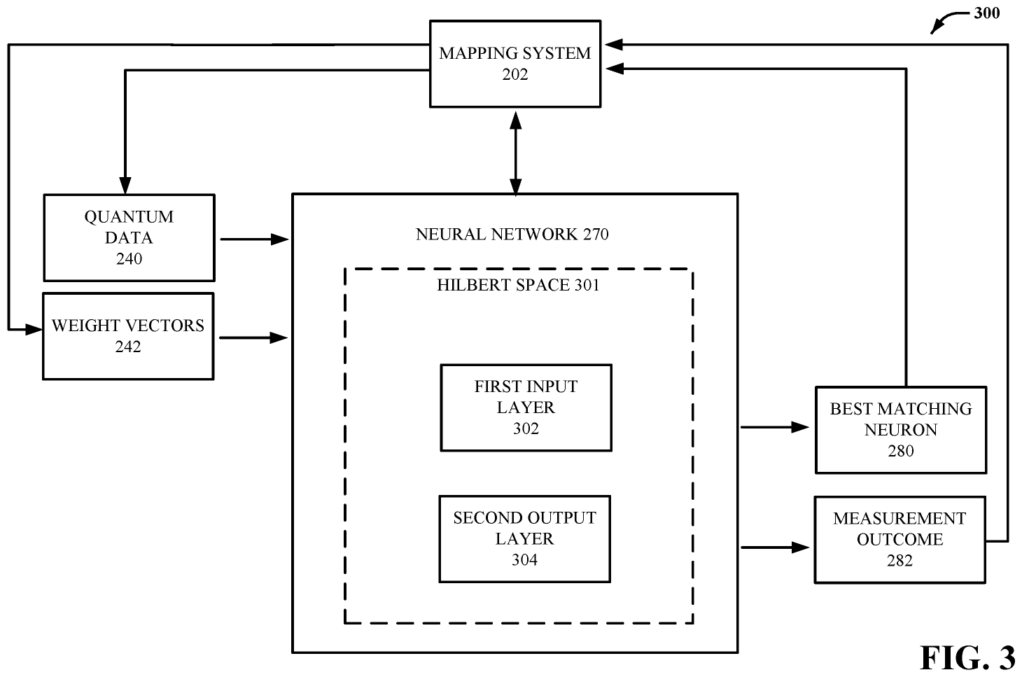

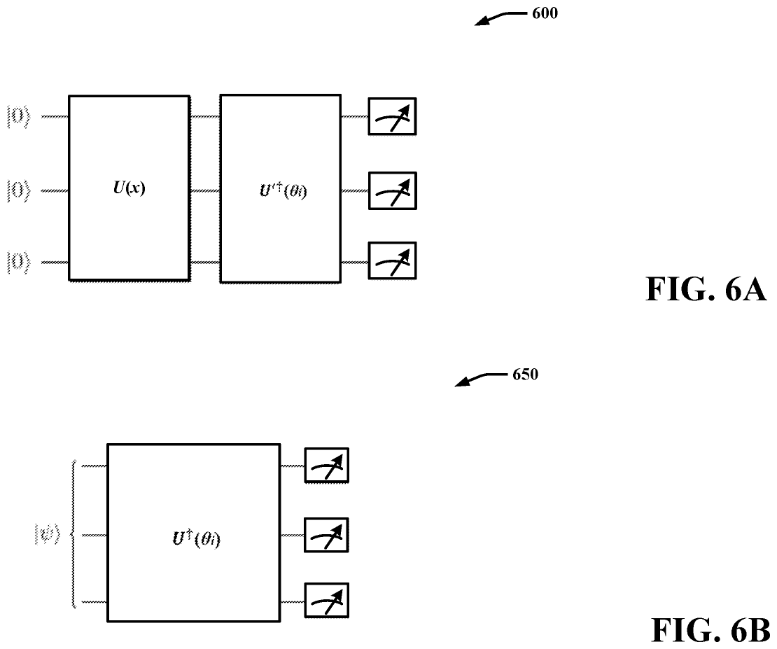

Description next turns to FIG. 3, and also to the encoding component 214 of FIG. 2. Generally, the encoding component 214 can encode the set of quantum data 240 and the set of variational parameters into the neural network 270. For example, this encoding can be facilitated using processes to encode quantum data to neurons of the neural network 270, which processes are understood by one having ordinary skill in the art and thus are not explained herein for sake of brevity. For example, a function U (x) can be employed to map classical data x onto a quantum state using a unitary matrix U, as shown at FIG. 6A. In one or more embodiments a state (\Psi>can be a quantum state that is a result of a quantum simulation (FIG. 6B).

As noted above, it also will be appreciated that the data encoded to the input layer can be classical data, as opposed to quantum data. In such case, quantum feature mapping and/or one or more other suitable techniques can be employed to map the classical data to quantum states. For example, using Equation 1, the encoding component 214 can map a set of classical data x into a set of quantum data ρ(x).

$$Φ : x \to ρ ( x ) = \vert U ( x ) 〉 〈 {U}^{†} ( x ) \vert . \qquad Equation 1$$

At Equation 1, U (x) is a unitary composed of quantum gates.

As illustrated at FIG. 3, the mapping system 202 (e.g., the encoding component 214) can encode the set of quantum data 240 into a first input layer 302 of neurons of a Hilbert space 301 of the neural network 270.

The encoding component 214 further can encode the set of variational parameters, such as the set of weight vectors 242, into a second output layer 304 of neurons of the Hilbert Space 301 of the neural network. The output layer 304 can have a predefined or selectable topology, such as a grid, such as a rectangular or hexagonal grid providing a lattice of neurons {l₁, . . . lₖ}∈L where l are the neurons and L is the low-dimensional lattice space of the grid of the output layer 304.

The first input layer 302 can be a higher-dimensional space than a dimensional space of the second output layer 304. In this way, upon training of the neural network 270, the neural network 270 can learn the mapping from the higher-dimensional Hilbert space of the first input layer 302 to the lower-dimensional Hilbert space of the second output layer 304.

Based on the encoded input and output layers 302 and 304, the mapping system 202 can aid the neural network 270 in this training (e.g., learning of the mapping), resulting in the trained neural network 270 being a variational quantum self-organizing map (variational QSOM). That is, upon encoding, distances between neurons of the input and output layers 302, 304 can be estimated, and the variational parameters at the output layer 304 can be updated based on the distances. These processes are described below in detail.

For example, turning next to the estimating component 216, and still to FIGS. 2 and 3, the estimating component 216 generally can execute a set of quantum circuits at a quantum processor (e.g., of the quantum system 401) resulting in measured outputs defining estimated inner products between a sample quantum state, of the set of quantum data 240, and the set of variational parameters (e.g., a set of weight vectors 242), associated with neurons the a lattice space of the second output layer 304 of the neural network 270. That is, the estimating component 216 can execute the set of quantum circuits by sending, or otherwise making available, the set of quantum circuits to the quantum processor. The quantum system 401 can operate the quantum processor on a set of one or more qubits, with measurement outputs defining one or more changes to the qubits representing the estimated inner products. Subsequently, based on the measurement readouts from the quantum processor, the estimated inner products can be determined by the estimating component.

That is, while the estimating component 216 can operate at a classical system comprising the mapping system 122, the classical system, by way of the estimating component 216, can employ the quantum system 401 to obtain the measurement readouts representing the estimated inner products. One or more additional classical processes can be performed, such as by the estimating component 216 to determine the estimated inner products from the measurement readouts. These processes will now be explained in further detail, below.

First, the set of quantum circuits can be generated, sent to and/or otherwise made available to the quantum system 401 by the estimating component 216. The set of quantum circuit can represent the calculations for determining the inner products between the single sample quantum state and each of the weight vectors of the set of weight vectors 242. To further train the neural network 270, additional sets of quantum circuits, representing calculations for determining the inner products between all other single quantum states of the set of quantum data 140 and each of the weight vectors of the set of weight vectors 142, also can be executed by the estimating component 116.

As a lower level, but still general explanation, the estimated inner products can represent transition probabilities between states of the input layer 302 and states of the output layer 304. These transition probabilities can be employed to generate the fidelities between the states. The fidelities, such as Hilbert-Shmidt norms, upon generation, can be employed by the estimating component 216 to determine a best matching neuron 180 of the output layer 304 to the neuron of the input layer 302 representing the sample quantum state being analyzed at the present iteration. The Hilbert-Shmidt norms represent the distances between the neurons of the input layer 302 and the neurons of the output layer 304 within the Hilbert space 301 of the neural network 270.

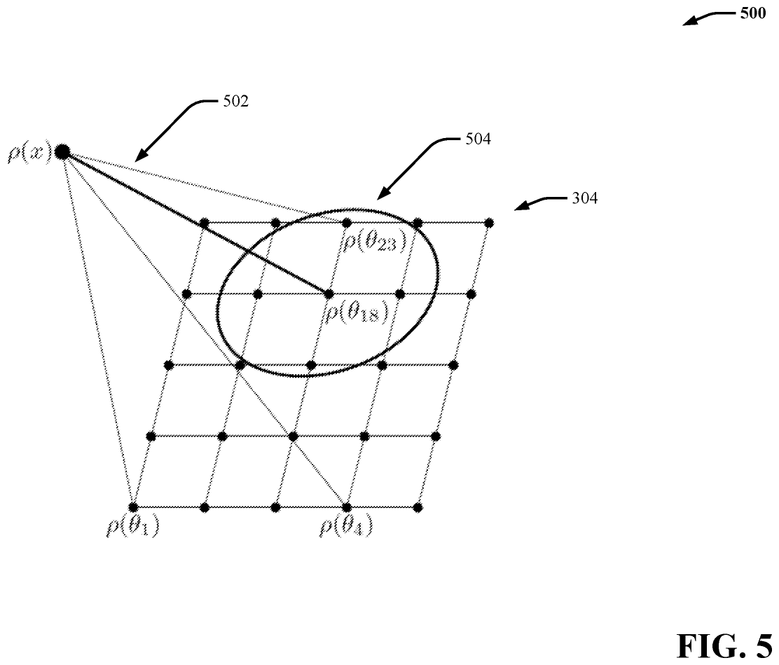

See, for example, the illustration 500 at FIG. 5. As illustrated at FIG. 5, ρ(x)∈ [symbol] ( [symbol] ) where ρ(x) is the set of quantum data 240 and [symbol] ( [symbol] ) refers to the higher-dimensional continuous Hilbert space which is learned by the NN to the lower-dimensional lattice space of the output layer 304, and thus [symbol] ( [symbol] ) refers to the set of all bounded operators on the Hilbert space 301 of quantum states of the set of quantum data 240. That is, FIG. 5, ρ(x) is the data of the input layer 302 (which is not particularly shown) and the output layer 304 is illustrated as a grid of lattice points, with each point representing a neuron of the NN 270 assigned to the output layer 304.

To each lattice point in the grid is associated a weight vector ρ(θᵢ)∈ [symbol] ( [symbol] ) The θᵢ's correspond to the angles in the Pauli-rotation gates of quantum gates representing the variational parameters. The distances 502 between a first sample quantum state of the set of quantum data 240 and the set of weight vectors 242 ({ρ(θ₁), . . . , ρ(θₖ)}) of the lattice L are illustrated.

More particularly, fully detailing the above, for a first sample quantum state represented by a single neuron of the input layer 302, a first set of quantum circuits can be sent to the quantum system 401 as a first quantum job request 424. This first set of quantum circuits represents the inputs necessary to perform on the set of qubits 407 of the quantum processor 406 to determine the transition probabilities between the first sample quantum state and each quantum state represented by the output layer 304. Quantum circuit illustration 600 at FIG. 6 represents a diagram of but one quantum circuit that can be employed to estimate a transition probability between the first sample quantum state and one quantum state corresponding to one weight vector of the set of weight vectors 242 represented at the output layer 304.

In one or more embodiments, a goal of this quantum circuit architecture can be to estimate an overlap between weights of all the neurons and select the neuron that generates the greatest number of a bitstring with all 0's. For example, a kernel value can be estimated on a quantum computer by calculating the ratio of a bit string comprising all 0's, to all the other bit strings containing every possible combination of 0's and 1's.

The first set of quantum circuits/first quantum job request 424 is obtained by the quantum system 401, which operates on the qubits 407 of the quantum processor 406. As a result, one or more quantum measurement readouts 420 are transferred back to the classical mapping system 202 and/or otherwise made available to the classical mapping system 202 by the readout electronics 412 of the quantum system 401. It is noted that a description detailing the functioning of the quantum system 401 is provided below, so as to not detour too greatly here from the present explanation.

These one or more quantum measurement readouts 420 are employed to determine the transition probabilities to then generate fidelities, such as Hilbert-Shmidt norms, by the fidelity component 218. For example, fidelity between two quantum states can be a Hilbert-Schmidt inner product between those two quantum states. This quantity can be estimated on a quantum computer by employing the corresponding unitary gates. The fidelity can be interpreted as the kernel entry K(x, x′).

For example, using Equation 2 the distances (e.g., distances 502 of FIG. 5) between the single neuron of the input layer 302 and each neuron of the output layer 304 can be determined. That is, a separate Equation 2 is employed for each pair of the single neuron and a different one of the neurons of the output layer 304. Each of these separate Equation 2's can be described as a fidelity-based metric.

$$d [ ρ ( x ) , ρ ( {θ}_{{i}^{*}}^{t} ) ] , \qquad Equation 2$$

where the second element in the bracket represents a single weight vector of the set of weight vectors 242.

Subsequently, using the Equation 3, the distances between the single neuron of the input layer 302 and each neuron of the output layer 304 can be compared to one another, with the minimum distance being identified by the determining component 220. That is, the determining component 220 can employ the fidelities (e.g., Hilbert Shmidt norms) in a fidelity-based metric of Equation 3 to identify the best matching neuron 280 (e.g., l*), which also can be referred to as a best matching unit or BMU to the single sample quantum state of ρ(x). For example, the minimum distance corresponds to the best matching neuron 280 of the output layer 304, which has the shortest distance (e.g., is closest to) within the Hilbert space 301 to the single neuron of the input layer 302 representing the sample quantum state being analyzed.

$$d [ ρ ( x ) , ρ ( {θ}_{{i}^{*}}^{t} ) ] = {min}_{i} \{ d [ ρ ( x , ρ ( {θ}_{i}^{t} ) ) ] \} . \qquad Equation 3$$

Based on the identification of the best matching neuron 280, modification to the variational parameters represented by the neurons of the lattice of the output layer 304 can be implemented by the updating component 222. These processes of the estimating component 216, fidelity component 218, determining component 220 and updating component 222 are completed for each single neuron of the input layer 302 until all of the neurons of the input layer 302 have been analyzed.

It is noted that the neurons of the input layer 302 can be analyzed in any order. It also is noted that relative to each of the single neurons of the input layer 302, the separate distances between the single neuron and each of the neurons of the output layer 304 can be determined in any order of the neurons of the output layer 304. Further, one or more measurement readouts 420 for one pair of quantum states can be employed by the fidelity component 218 and/or the determining component 220 in parallel with processes performed by the fidelity component 218 and/or determining component 220 relative to other one or more measurement readouts 420, and/or in parallel with one or more operations of additional quantum circuits by the quantum system 401 relative to one or more other pairs of quantum states (e.g., relative to the same single neuron of the input layer 302 or from relative to one or more other single neurons of the input layer 302). Indeed, the quantum system 401 can operation one or more quantum circuits relative to the first single neuron of the input layer 302 in parallel with one or more additional quantum circuits relative to another single neuron of the input layer 302 at least partially in parallel with one another. In these ways, the processes of the classical mapping system 202 and the quantum system 401 can be scalable.

Before continuing with description of the updating processes performed by the updating component 222, direction first turns to function of the quantum system 401, the operation of which allowed for the output of the quantum measurement readouts 420 and thus allowed for the determination of the best matching neuron 280 in the first instance.

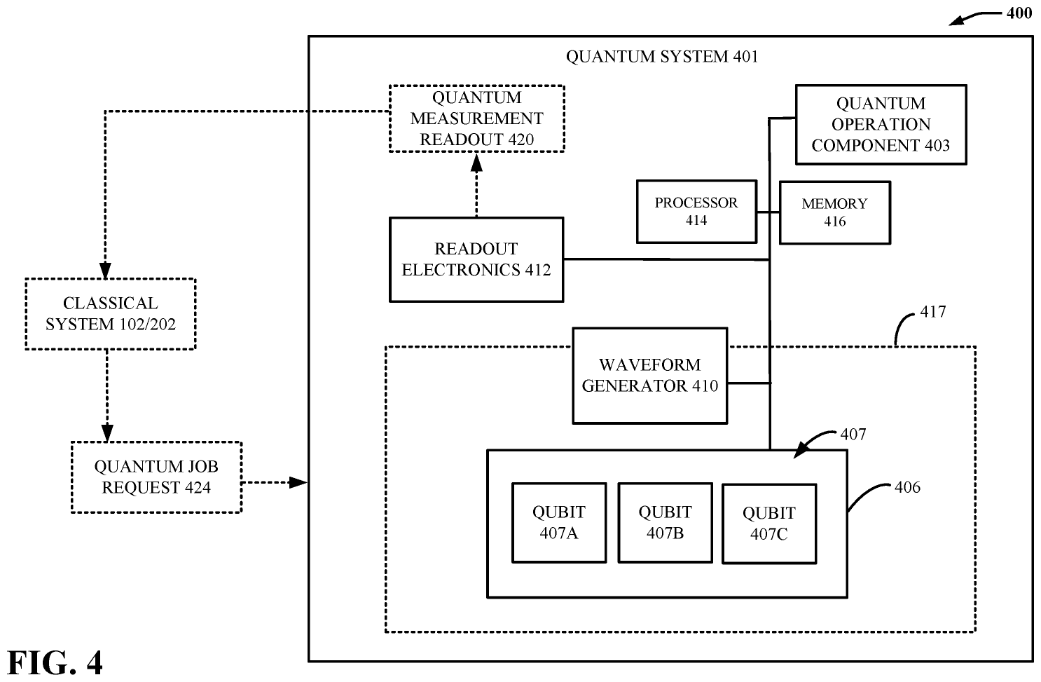

That is, turning to FIG. 4, one or more embodiments described herein can include one or more devices, systems and/or apparatuses that can provide a process to generate one or more waveforms for a quantum-based operation (e.g., using a quantum device), such as for operating one or more qubits of a quantum device. Accordingly, at FIG. 4, illustrated is a block diagram of an example, non-limiting system 400 that can at least partially facilitate such a process. While referring here to one or more processes, facilitations and/or uses of the non-limiting system 400, description provided herein, both above and below, also can be relevant to one or more other non-limiting systems described herein, such as the non-limiting systems 100 and/or 200.

As illustrated at FIG. 4, the non-limiting system 400 can comprise a quantum system 401 that can be employed with or separate from the classical systems 102/202.

Generally, the quantum system 401 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 420, can be responsive to the quantum job request 424 and associated input data and can be based at least in part on the input data, quantum functions and/or quantum computations.

In one or more embodiments, the quantum system 401 can comprise components, such as a quantum operation component 403, a quantum processor 406, pulse component 410 (e.g., a waveform generator) and/or a readout electronics 412 (e.g., readout component). In one or more other embodiments, the readout electronics 412 can be comprised at least partially by the classical system 102/202 and/or be external to the quantum system 401. The quantum processor 406 can comprise one or more, such as plural, qubits 407. Individual qubits 407A, 407B and 407C, for example, can be fixed frequency and/or single junction qubits, such as transmon qubits.

In one or more embodiments, a memory 416 and/or processor 414 can be associated with the quantum operation component 403, where suitable. The processor 414 can be any suitable processor. The processor 414 can generate one or more instructions for controlling the one or more processes of the quantum operation component 403.

The quantum operation component 403 can obtain (e.g., download, receive, search for and/or the like) a quantum job request 424 requesting execution of one or more quantum programs and/or a physical qubit layout. The quantum job request 424 can be provided in any suitable format, such as a text format, binary format and/or another suitable format. In one or more embodiments, the quantum job request 424 can be obtained by a component other than of the quantum system 401, such as a by a component of the classical systems 102/202.

The quantum operation component 403 can determine mapping of one or more quantum logic circuits for executing a quantum program. In one or more embodiments, the quantum operation component 403 and/or quantum processor 406 can direct the waveform generator 410 to generate one or more pulses, tones, waveforms and/or the like to affect one or more qubits 407, such as in response to a quantum job request 424.

The waveform generator 410 can generally cause the quantum processor 406 to perform one or more quantum processes, calculations and/or measurements by creating a suitable electro-magnetic signal. For example, the waveform generator 410 can operate one or more qubit effectors, such as qubit oscillators, harmonic oscillators, pulse generators and/or the like to cause one or more pulses to stimulate and/or manipulate the state(s) of the one or more qubits 407 comprised by the quantum system 401.

The quantum processor 406 and a portion or all of the waveform generator 410 can be contained in a cryogenic environment, such as generated by a cryogenic environment 417, such as effected by a dilution refrigerator. Indeed, a signal can be generated by the waveform generator 410 to affect one or more of the plurality of qubits 407. Where the plurality of qubits 407 are superconducting qubits, cryogenic temperatures, such as about 4K or lower, can be employed for function of these physical qubits. Accordingly, one or more elements of the readout electronics 112 also can be constructed to perform at such cryogenic temperatures.

The readout electronics 412, or at least a portion thereof, can be contained in the cryogenic environment 417, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning back to FIGS. 2 and 5, description of the updating processes performed by the updating component 222 are now described. For example, the updating component 222 can generally, based on the estimation of the inner products (e.g., fidelity between pairs of quantum states) and employing a quantum kernel, update a subset of the weight vectors of a corresponding subset of the neurons of the lattice space L that have a selected proximity to the best matching neuron 280. For example, the subset of adjustable weights can be disposed within a selected threshold distance of the best matching neuron 280, as defined by a suitable neighborhood function.

For example, turning to FIG. 5, the circle 504 can represent the neighborhood within which lie the neurons of the lattice space L that are to be updated. That is, only those variational parameters of neurons on and/or within, depending on the neighborhood function employed) are to be updated by the updating component 222.

The neighborhood function can be a hyperparameter that can be selected by an administrating entity, and/or by the mapping system 202, to effect modification of the variational parameters of the lattice space L of the output layer 304 after the determination of each separate best matching neuron 280. In one example, a Gaussian functional form can be employed, as shown below in Equation 4.

$$h ( x ) = exp ( - \frac{{x}^{2}}{2 {σ}^{2}} ) . \qquad Equation 4$$

For example, employing the quantum kernel by the updating component 222 can comprise determining, by the updating component 222, gradients of kernel functions employing parameter shift rules and eigenvalues of Pauli gates corresponding to the gradients.

Equation 5 and 6 invoke the quantum kernel to update the parameters of the variational gates. The quantum kernel can be represented by K, such as K(θ,x). K represents the kernel element that can be calculated on a quantum computer by embedding the classical data and the variational parameters in an appropriate variational ansatz.

The parameter shift rule can refer to the calculation of gradients of functions of quantum circuits with respect to a variational parameter. The gradient of a function, which gradient corresponds to an expectation value of an operator composed of a unitary ansatz and the measurement operator, can be estimated using additional evaluations of quantum circuits with variational parameters shifted according to the eigenvalues of the unitary ansatz.

Equation 5 can provide a rule by which the vector weight update process of the updating component 222 is governed (e.g., which the updating component 222 can employ).

Further, the first term in Equation 5 can vanish because K(θ, θ)=1, and thus the Equation 5 can be modified to Equation 6. For example, the kernel value K corresponds to the overlap of a state with itself. The overlap is equal to 1 regardless of the value of θ is. Thus the answer is always equal to 1. As such, the derivative of a kernel value with respect to θ is always 0 and the first term can vanish.

$${θ}_{i}^{t + 1} = {θ}_{i}^{t} - {α}^{t} {h}^{t} ( \frac{\partial }{\partial θ} K ( θ , θ ) {\vert}_{{θ}_{i}^{t}} - 2 \frac{\partial }{\partial θ} K ( x , θ ) {\vert}_{{θ}_{i}^{t}} ) . \qquad Equation 5$$

$${θ}_{i}^{t + 1} = {θ}_{i}^{t} + 2 {α}^{t} {h}^{t} \frac{\partial }{\partial θ} K ( x , θ ) {\vert}_{{θ}_{i}^{t}} . \qquad Equation 6$$

With respect to Equation 6, the gradients of the kernel functions can be calculated using parameter shift rules as provided at Equation 7.

$$\frac{\partial }{\partial θ} K ( x , θ ) {\vert}_{{θ}_{i}^{t}} = \frac{K ( x + ϕ , θ + ϕ ) - K ( x - ϕ , θ - ϕ )}{2 sin ( ω ϕ ) / ω} , \qquad Equation 7$$

where ω corresponds to the eigen values of the Pauli gates.

That is, the above Equations 5, 6 and 7 assume that the kernel K is a function of Pauli rotation gates and the gradient with respect to θ requires the knowledge of the eigenvalue of the corresponding Pauli gate containing theta. So, for example, if the theta is encoded in RZ Pauli rotation gate, then omega would correspond to the eigenvalues of Z Pauli gate

After each iteration of updating performed by the updating component 222, the evaluating component 224 can determine whether or not any additional sample quantum state of the set of quantum data 240 of the input layer 302 remains to be analyzed.

Where an additional sample quantum state remains to be analyzed, the estimating component 216, fidelity component 218, determining component 220 and updating component 222 can perform their respective processes. That is, the variational parameters as updated by the updating component 222 in the previous iteration can be further updated as a result of subsequent iterations of determination of the best matching neurons and corresponding updating processes performed by the updating component 222.

That is, the estimating component 216 can execute additional sets of quantum circuits at the quantum processor 406 resulting in additional measured outputs 282 defining additional estimated inner products between additional sample quantum states, of the set of quantum data 240, and the set of weight vectors 242. The fidelity component 218 can employ the additional estimated inner products to generate additional fidelities for the additional sample quantum states. The determining component 220, based on the additional fidelities, and thus on the additional estimated inner products, can identify additional best matching neurons 280 to the additional sample quantum states.

Where all sample quantum states of the set of quantum data 240 have been analyzed, the evaluating component 224 can transmit, and/or otherwise make available, a notification that the NN 270 has learned the topology-preserving map κ(ρ(x)).

That is, as set forth at Equation 12, the topology-preserving map κ(ρ(x)) can have been learned by the NN 270 from the higher-dimensional continuous space [symbol] ( [symbol] ) to the lower-dimensional lattice space L of k neurons. That is, [symbol] ( [symbol] ) refers to the space of all bounded operators in the Hilbert space (Quantum), whereas the [symbol] ^{N} is the space of the original classical data. The first arrow (i.e. from [symbol] ^{N} to [symbol] ( [symbol] ) represents mapping classical data onto quantum computers via quantum gates.

$$κ ( ρ ( x ) ) : {ℝ}^{N} \to ℬ ( ℋ ) \to L . \qquad Equation 12$$

As a result of the learning of the topology-preserving map κ(ρ(x)) by the NN 270, thus resulting in a SOM 270, or more particularly, a variational QSOM 270, one or more inference processes can be performed by the inference component 226.

That is, generally, the inference component 226 can, for an inference sample quantum state, based on the neural network 270 having been trained on the set of quantum data 240, direct the estimating component 216, fidelity component 218 and determining component 220 to perform the respective executing, generating and identifying, resulting in identification of an inferred best matching neuron to the inference sample quantum state. It is noted that in this inference stage, the updating component 222 is no longer updating the variational parameters of the lower-dimensional lattice space L of k neurons.

In one or more embodiments, the inferencing directed by the inference component 226 (and the processes performed by the estimating component 216, fidelity component 218 and determining component 220) can be performed for more than one inference sample quantum state or sample classical data (and thus also including processes performed by the encoding component 214) at least partially in parallel with one another.

Turning briefly to the quantum circuit 650 at FIG. 6B, the processes performed by the mapping system 202 can be expanded to learn the topological structure of quantum data generated by quantum simulations of quantum materials, as represented by the quantum circuit 650. As such, the variational QSOM 270 can create clusters from a collection of unknown quantum states obtained from a quantum simulation of one or more quantum systems (e.g., quantum system 401).

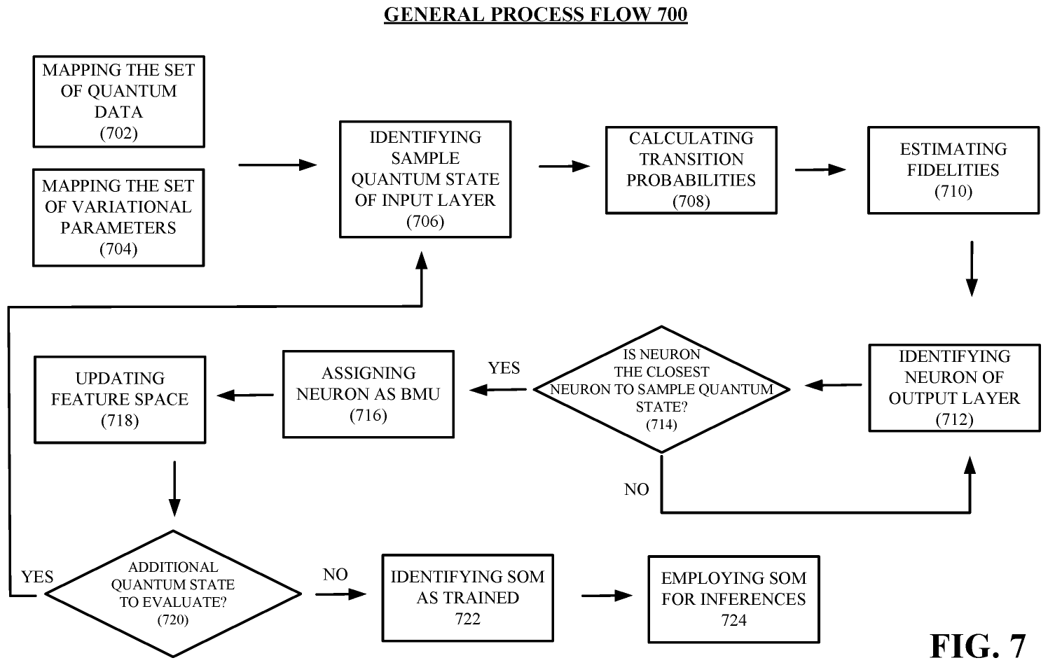

Turning next to FIG. 7, illustrated is a general process flow 700 that serves as a summary of the above descriptions of processes that can be performed by the components of the mapping system 202.

For example, mapping of the set of quantum data at step 702 (e.g., by the encoding component 214) and of the variation parameters at step 704 (e.g., by the encoding component 214) to the first input layer 302. A first sample quantum state of the input layer 302 can be identified at step 706 (e.g., by the estimating component 216). The estimating component 216 can calculate transition probabilities for the sample quantum states at step 708, and the fidelity component 218 can estimate corresponding fidelities at step 710. This estimating can comprise evaluation relative to the sample quantum state and each quantum state based on each neuron of the second output layer 304 (e.g., at step 712). At step 714, the determining component 220 can determine which neuron of the output layer 304 is closest to the neuron of the input layer 302 corresponding to the sample quantum state. Additional quantum state pair can be analyzed by the estimating (e.g., based on additional neurons of the output layer at additional steps 712.

The determining component 220 can determine a neuron of the output layer 304 as the best matching neuron 280, at step 716. Based on this determination, the feature space of the output layer 304 can be updated at step 718 by the updating component 222. These processes can be repeated a plurality of times for additional sample quantum states corresponding to the input layer 302 (e.g., at step 720). Where there is no additional sample quantum state corresponding to the input layer left to analyze, as determined by the estimating component 216, the general process flow 700 can proceed forward to step 722. At step 722, the SOM can be identified by the system 202 as being trained. At step 724, the SOM can be employed by the inference component 226 for one or more inferences relative to one or more additional sample quantum states.

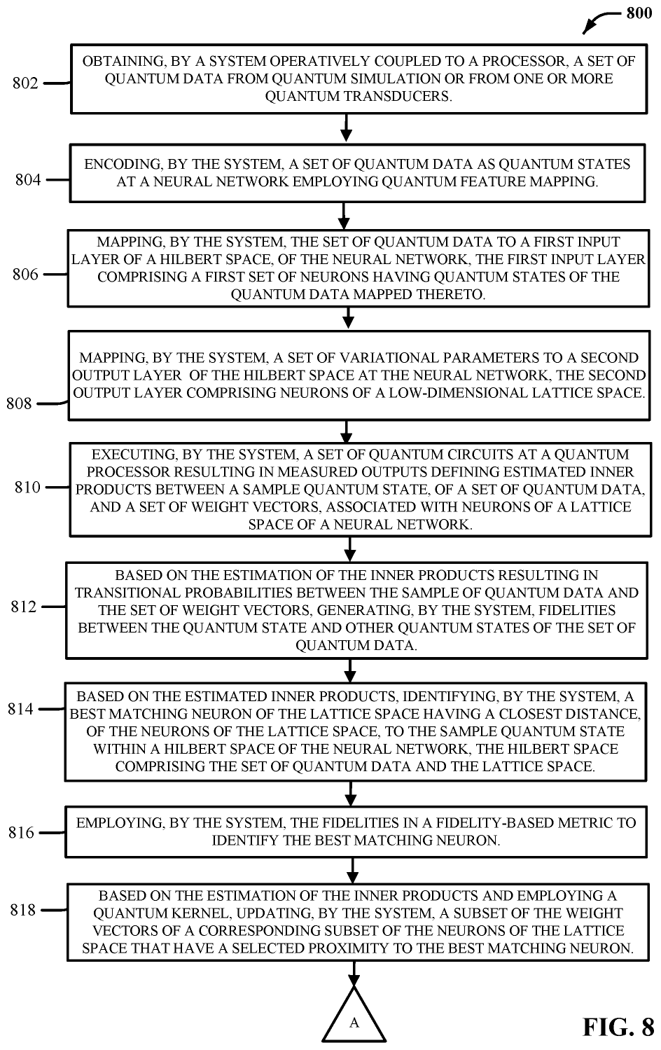

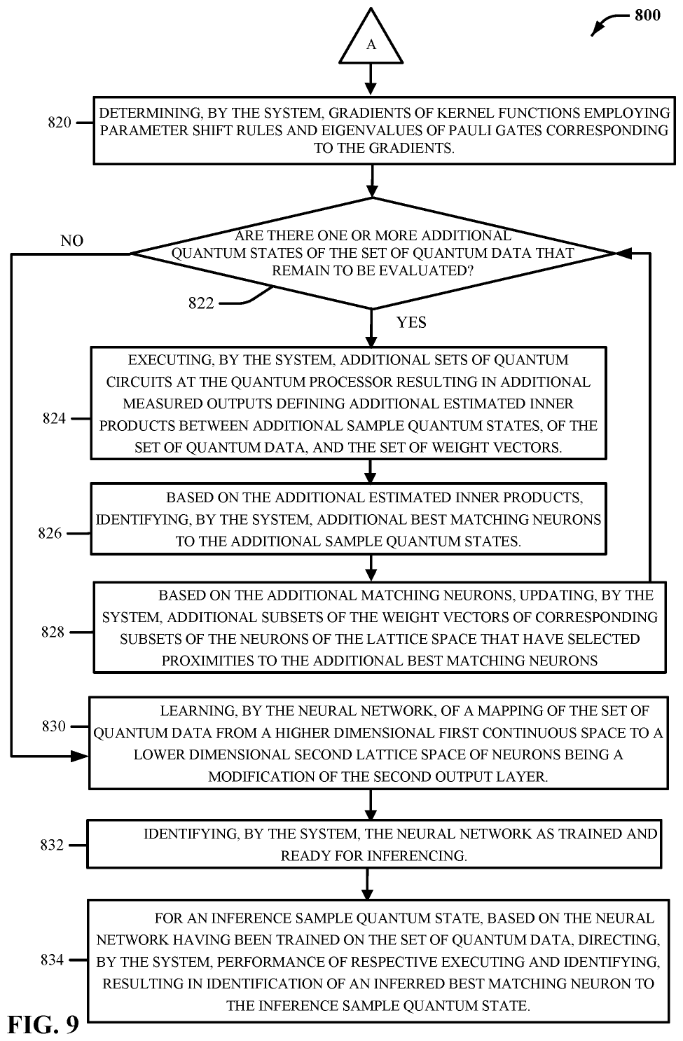

As another summary, referring next to FIGS. 8 and 9, illustrated is a flow diagram of an example, non-limiting method 800 that can provide a process train a neural network as a SOM, using a quantum processor, and to provide predictive estimation based on input quantum data, in accordance with one or more embodiments described herein, such as the non-limiting system 200 of FIG. 2. While the non-limiting method 800 is described relative to the non-limiting system 200 of FIG. 2, the non-limiting method 800 can be applicable also to other systems described herein, such as the non-limiting system 100 of FIG. 1. Repetitive description of like elements and/or processes employed in respective embodiments is omitted for sake of brevity.

At 802, the non-limiting method 800 can comprise obtaining, by a system operatively coupled to a processor (e.g., obtaining component 212), a set of quantum data (e.g., set of quantum data 240) from quantum simulation or from one or more quantum transducers (e.g., from quantum system 401).

At 804, the non-limiting method 800 can comprise encoding, by the system (e.g., encoding component 214), the set of quantum data as quantum states (e.g., the sample quantum state) at a neural network (e.g., neural network 270) employing quantum feature mapping.

At 806, the non-limiting method 800 can comprise mapping, by the system (e.g., encoding component 214), the set of quantum data to a first input layer (e.g., first input layer 302) of a Hilbert space (e.g., Hilbert space 301) of the neural network, the first input layer comprising a first set of neurons having quantum states of the quantum data mapped thereto.

At 808, the non-limiting method 800 can comprise mapping, by the system (e.g., encoding component 214), a set of variational parameters (e.g., weight vectors 242) to a second output layer (e.g., second output layer 304) of the Hilbert space at the neural network, the second output layer comprising neurons of a low-dimensional lattice space.

At 810, the non-limiting method 800 can comprise executing, by the system (e.g., estimating component 216), a set of quantum circuits at a quantum processor (e.g., quantum processor 406 of quantum system 401) resulting in measured outputs (e.g., measured outputs 282) defining estimated inner products between a sample quantum state, of a set of quantum data, and the set of variational parameters, such as a set of weight vectors (e.g., weight vectors 242), associated with neurons of a lattice space of the neural network.

In one or more embodiments, the inner products represent transition probabilities between the sample quantum state and states corresponding to the set of weight vectors.

At 812, the non-limiting method 800 can comprise, based on the estimation of the inner products resulting in transitional probabilities between the sample of quantum data and the set of weight vectors, generating, by the system (e.g., fidelity component 218), fidelities between the quantum state and other quantum states of the set of quantum data.

At 814, the non-limiting method 800 can comprise based on the estimated inner products, identifying, by the system (e.g., determining component 220), a best matching neuron (e.g., best matching neuron 280) of the lattice space having a closest distance, of the neurons of the lattice space, to the sample quantum state within a Hilbert space of the neural network, the Hilbert space comprising the set of quantum data and the lattice space.

At 816, the non-limiting method 800 can comprise employing, by the system (e.g., determining component 220), the fidelities in a fidelity-based metric to identify the best matching neuron.

At 818, the non-limiting method 800 can comprise, based on the estimation of the inner products and employing a quantum kernel, updating, by the system (e.g., updating component 222), a subset of the weight vectors of a corresponding subset of the neurons of the lattice space that have a selected proximity to the best matching neuron.

In I one or more embodiments, the subset of adjustable weights is disposed within a selected threshold distance of the neuron.

At 820, the non-limiting method 800 can comprise determining, by the system (e.g., updating component 222), gradients of kernel functions employing parameter shift rules and eigenvalues of Pauli gates corresponding to the gradients. (Sec, e.g., Equations 5-7.)

At 822, the non-limiting method 800 can comprise determining, by the system (e.g., estimating component 216), if additional quantum states of the set of quantum data remain to be evaluated. If yes, the non-limiting method 800 can proceed to step 824. If not, the non-limiting method 800 can proceed to step 830.

At 824, the non-limiting method 800 can comprise executing, by the system (e.g., evaluating component 224), additional sets of quantum circuits at the quantum processor resulting in additional measured outputs (e.g., measured outputs 282) defining additional estimated inner products between additional sample quantum states, of the set of quantum data, and the set of weight vectors.

At 826, the non-limiting method 800 can comprise, based on the additional estimated inner products, identifying, by the system (e.g., determining component 220), additional best matching neurons to the additional sample quantum states.

At 828, the non-limiting method 800 can comprise, based on the additional matching neurons, updating, by the system (e.g., updating component 222), additional subsets of the weight vectors of corresponding subsets of the neurons of the lattice space that have selected proximities to the additional best matching neurons.

At 830, the non-limiting method 800 can comprise learning, by the neural network (e.g., neural network 270), of a mapping of the set of quantum data from a higher dimensional first continuous space to a lower dimensional second lattice space of neurons being a modification of the second output layer.

At 832, the non-limiting method 800 can comprise identifying, by the system (e.g., evaluating component 224), the neural network as trained and ready for inferencing.

At 834, the non-limiting method 800 can comprise, for an inference sample quantum state, based on the neural network having been trained on the set of quantum data, directing, by the system (e.g., evaluating component 224), performance of respective executing and identifying, resulting in identification of an inferred best matching neuron to the inference sample quantum state.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, computer program products and/or computer-implemented methods described herein relate to generating and using a self-organizing map based on a quantum kernel approach. A system can comprise a memory that stores computer executable components and a processor that executes the computer executable components, which can comprise an estimating component that executes a set of quantum circuits at a quantum processor resulting in measured outputs defining estimated inner products between a sample quantum state, of a set of quantum data, and a set of weight vectors, associated with neurons of a lattice space of a neural network, and a determining component that, based on the estimated inner products, identifies a best matching neuron of the lattice space having a closest distance, of the neurons of the lattice space, to the sample quantum state within a Hilbert space, comprising the set of quantum data and the lattice space, of the neural network.

A benefit of the one or more systems, computer program products and/or computer-implemented methods can be an ability to, employing a NN, map a set of quantum data to a Hilbert space using quantum feature mapping, initialize a set of variational parameters (e.g., weights) at the Hilbert space, estimate fidelities between input and output layers of the Hilbert space, adjust a feature space of the output layer of the Hilbert space based on the estimated fidelities, and perform inference of additional quantum data upon having trained a NN as a SOM.

Another benefit of the one or more systems, computer program products and/or computer-implemented methods can be an ability to, by employing the power of a quantum processor, process exceedingly complicated data structures to thereby train the NN as existing approaches have failed to do. That is, by generating quantum circuits representing calculations for inner products between the inner and outer layers of the Hilbert space, directing execution of the quantum circuits on the quantum processor, and obtaining measurement readouts from the quantum processor, the one or more embodiments described herein can facilitate previously unattainable training of a NN to a SOM, and/or can facilitate such training with previously unattainable efficiency, accuracy and/or timing. Furthermore, the training can be completed in a way that can preserve topology of an initially-prepared lattice of neurons of the NN while learning a mapping of a high-dimensional Hilbert space to a low-dimensional lattice grid at the initially-prepared lattice.

Indeed, in view of the one or more embodiments described herein, a practical application of the one or more systems, computer-implemented methods and/or computer program products described herein can be the obtaining of quantum advantage for training of a NN as a SOM. That is, the one or more embodiments described herein can provide the ability to quickly and efficiently process a structurally-complicated set of quantum data using a quantum computer to train a NN as a SOM in what would otherwise be, using existing techniques, an impossible or difficult training process. Such training can be employed for SOMs relative to various purposes, such as, but not limited to, clustering, dimensionality reduction and/or low-dimensional topology preserving visualizations of high-dimensional datasets. Such SOMs can be useful in fields of finance, biology, chemistry, materials science, pharmacology and/or drug-delivery, without being limited thereto. Accordingly, the one or more embodiments described herein provide useful and practical applications of computers, thus providing enhanced (e.g., improved and/or optimized) neural network training resulting in enhanced data analysis and prediction output. Overall, such computerized tools can constitute a concrete and tangible technical improvement in the fields of artificial intelligence and neural networks.

Furthermore, one or more embodiments described herein can be employed in a real-world system based on the disclosed teachings. For example, one or more embodiments described herein can function with a neural network to train the neural network, where the neural network can thereafter be employed for various inference actions relative to sample quantum data.

Moreover, one or more embodiments described herein can be implemented in one or more domains to enable scaled prediction output and/or model training. Indeed, use of a system as described herein can be scalable, such as where plural input datasets (e.g., comprising data) can be evaluated and employed to train one or more neural networks as self-organizing mapping NNs, at least partially in parallel at a same time as one another. For example, the processes performed by the mapping systems 102/202 can scale linearly in the number of quantum data samples given that there are a predefined number of quantum states parameterized by the variational parameters in the output layer 304.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to neural network training and inferencing, as compared to existing systems and/or techniques. Systems, computer-implemented methods and/or computer program products providing performance of these processes are of great utility in the fields of neural network predictions and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically use a quantum processor training to quickly and efficiently train a NN as a SOM as the one or more embodiments described herein can provide this process. Moreover, neither can the human mind nor a human with pen and paper conduct such process, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein. To provide additional summary, a listing of embodiments and features thereof is next provided.

A system, comprising: a memory that stores computer executable components; and a processor that executes the computer executable components stored in the memory, wherein the computer executable components comprise: an estimating component that executes a set of quantum circuits at a quantum processor resulting in measured outputs defining estimated inner products between a sample quantum state, of a set of quantum data, and a set of weight vectors, associated with neurons of a lattice space of a neural network; and a determining component that, based on the estimated inner products, identifies a best matching neuron of the lattice space having a closest distance, of the neurons of the lattice space, to the sample quantum state within a Hilbert space of the neural network, the Hilbert space comprising the set of quantum data and the lattice space.

The system of the previous paragraph, further comprising: an updating component that, based on the estimation of the inner products and employing a quantum kernel, updates a subset of the weight vectors of corresponding subset of the neurons of the lattice space that have a selected proximity to the best matching neuron, wherein the subset of adjustable weights is disposed within a selected threshold distance of the best matching neuron.

The system of any previous paragraph, wherein employing the quantum kernel by the updating component comprises determining, by the updating component, gradients of kernel functions employing parameter shift rules and eigenvalues of Pauli gates corresponding to the gradients.

The system of any previous paragraph, wherein the inner products represent transition probabilities between the sample quantum state and states corresponding to the set of weight vectors.

The system of any previous paragraph, further comprising: a fidelity component that, based on the estimation of the inner products resulting in transitional probabilities between the sample of quantum data and the set of weight vectors, generates fidelities between the quantum state and other quantum states of the set of quantum data, wherein the determining component employs the fidelities in a fidelity-based metric to identify the best matching neuron.

The system of any previous paragraph, wherein the Hilbert space comprises a first input layer comprising a first set of neurons having the sample quantum state and other quantum states of the set of quantum data mapped to the first set of neurons, and wherein the Hilbert space further comprises a second output layer comprising the neurons of the lattice space.

The system of any previous paragraph, wherein the estimating component executes additional sets of quantum circuits at the quantum processor resulting in additional measured outputs defining additional estimated inner products between additional sample quantum states, of the set of quantum data, and the set of weight vectors, wherein the determining component, based on the additional estimated inner products, identifies additional best matching neurons to the additional sample quantum states, and wherein the execution and the additional execution performed by the estimating component, and the identification and the additional identification performed by the determining component, together result in learning by the neural network of a mapping of the set of quantum data from a higher dimensional first continuous space to a lower dimensional second lattice space of neurons being a modification of the second output layer.

The system of any previous paragraph, further comprising: an inference component that, for an inference sample quantum state, based on the neural network having been trained on the set of quantum data, directs the estimating component and determining component to perform the respective executing and identifying, resulting in identification of an inferred best matching neuron to the inference sample quantum state.

The system of any previous paragraph, further comprising: an encoding component that encodes the set of quantum data as quantum states at the neural network employing quantum feature mapping.

The system of any previous paragraph, wherein the quantum data is obtained from quantum simulation or from one or more quantum transducers.

A computer-implemented method, comprising: executing, by a system operatively coupled to a processor, a set of quantum circuits at a quantum processor resulting in measured outputs defining estimated inner products between a sample quantum state, of a set of quantum data, and a set of weight vectors, associated with neurons of a lattice space of a neural network; and based on the estimated inner products, identifying, by the system, a best matching neuron of the lattice space having a closest distance, of the neurons of the lattice space, to the sample quantum state within a Hilbert space of the neural network, the Hilbert space comprising the set of quantum data and the lattice space.

The computer-implemented method of the preceding paragraph, further comprising: based on the estimation of the inner product and employing a quantum kernel, updating, by the system, a subset of the weight vectors of corresponding subset of the neurons of the lattice space that have a selected proximity to the best matching neuron, wherein the subset of adjustable weights is disposed within a selected threshold distance of the neuron.

The computer-implemented method of any preceding paragraph, wherein employing the quantum kernel comprises determining, by the system, gradients of kernel functions employing parameter shift rules and eigenvalues of Pauli gates corresponding to the gradients.

The computer-implemented method of any preceding paragraph, further comprising: based on the estimation of the inner products resulting in transitional probabilities between the sample of quantum data and the set of weight vectors, generating, by the system, fidelities between the quantum state and other quantum states of the set of quantum data; and employing, by the system, the fidelities in a fidelity-based metric to identify the best matching neuron.

The computer-implemented method of any preceding paragraph, further comprising: executing, by the system, additional sets of quantum circuits at the quantum processor resulting in additional measured outputs defining additional estimated inner products between additional sample quantum states, of the set of quantum data, and the set of weight vectors; and based on the additional estimated inner products, identifying, by the system, additional best matching neurons to the additional sample quantum states, and wherein the execution and the additional execution, and the identification and the additional identification, together result in learning by the neural network of a mapping of the set of quantum data from a higher dimensional first continuous space to a lower dimensional second lattice space of neurons.

A computer program product facilitating a process to generate a self-organizing map based on a quantum kernel approach, the computer program product comprising a computer readable storage medium having program instructions embodied therewith, the program instructions executable by a processor to cause the processor to: execute, by the processor, a set of quantum circuits at a quantum processor resulting in measured outputs defining estimated inner products between a sample quantum state, of a set of quantum data, and a set of weight vectors, associated with neurons of a lattice space of a neural network; and based on the estimated inner products, identify, by the processor, a best matching neuron of the lattice space having a closest distance, of the neurons of the lattice space, to the sample quantum state within a Hilbert space of the neural network, the Hilbert space comprising the set of quantum data and the lattice space.

The computer program product of the preceding paragraph, wherein the program instructions are further executable by the processor to cause the processor to: based on the estimation of the inner product and employing a quantum kernel, update, by the processor, a subset of the weight vectors of corresponding subset of the neurons of the lattice space that have a selected proximity to the best matching neuron, wherein the subset of adjustable weights is disposed within a selected threshold distance of the neuron.

The computer program product of any preceding paragraph, wherein the program instructions for employing the quantum kernel are further executable by the processor to cause the processor to: determine, by the processor, gradients of kernel functions employing parameter shift rules and eigenvalues of Pauli gates corresponding to the gradients.

The computer program product of any preceding paragraph, wherein the program instructions are further executable by the processor to cause the processor to: based on the estimation of the inner products resulting in transitional probabilities between the sample of quantum data and the set of weight vectors, generate, by the processor, fidelities between the quantum state and other quantum states of the set of quantum data; and employ, the by the processor, the fidelities in a fidelity-based metric to identify the best matching neuron.

The computer program product of any preceding paragraph, wherein the Hilbert space comprises a first input layer comprising a first set of neurons having the sample quantum state and other quantum states of the set of quantum data mapped to the first set of neurons, and wherein the Hilbert space further comprises a second output layer comprising the neurons of the lattice space.

### Computing Environment Description

Turning next to FIG. 10, a detailed description is provided of additional context for the one or more embodiments described herein at FIGS. 1-9.

FIG. 9 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the neural network training and inference code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine that collects and stores helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an estimating component that executes a set of quantum circuits at a quantum processor resulting in measured outputs defining estimated inner products between a sample quantum state, of a set of quantum data, and a set of weight vectors, associated with neurons of a lattice space of a neural network; and
a determining component that, based on the estimated inner products, identifies a best matching neuron of the lattice space having a closest distance, of the neurons of the lattice space, to the sample quantum state within a Hilbert space of the neural network, the Hilbert space comprising the set of quantum data and the lattice space.

2. The system of claim 1, further comprising:
an updating component that, based on the estimation of the inner products and employing a quantum kernel, updates a subset of the weight vectors of corresponding subset of the neurons of the lattice space that have a selected proximity to the best matching neuron,
wherein the subset of adjustable weights is disposed within a selected threshold distance of the best matching neuron.

3. The system of claim 2, wherein employing the quantum kernel by the updating component comprises determining, by the updating component, gradients of kernel functions employing parameter shift rules and eigenvalues of Pauli gates corresponding to the gradients.

4. The system of claim 1, wherein the inner products represent transition probabilities between the sample quantum state and states corresponding to the set of weight vectors.

5. The system of claim 1, further comprising:
a fidelity component that, based on the estimation of the inner products resulting in transitional probabilities between the sample of quantum data and the set of weight vectors, generates fidelities between the quantum state and other quantum states of the set of quantum data,
wherein the determining component employs the fidelities in a fidelity-based metric to identify the best matching neuron.

6. The system of claim 1,
wherein the Hilbert space comprises a first input layer comprising a first set of neurons having the sample quantum state and other quantum states of the set of quantum data mapped to the first set of neurons, and
wherein the Hilbert space further comprises a second output layer comprising the neurons of the lattice space.

7. The system of claim 6,
wherein the estimating component executes additional sets of quantum circuits at the quantum processor resulting in additional measured outputs defining additional estimated inner products between additional sample quantum states, of the set of quantum data, and the set of weight vectors,
wherein the determining component, based on the additional estimated inner products, identifies additional best matching neurons to the additional sample quantum states, and
wherein the execution and the additional execution performed by the estimating component, and the identification and the additional identification performed by the determining component, together result in learning by the neural network of a mapping of the set of quantum data from a higher dimensional first continuous space to a lower dimensional second lattice space of neurons being a modification of the second output layer.

8. The system of claim 1, further comprising:
an inference component that, for an inference sample quantum state, based on the neural network having been trained on the set of quantum data, directs the estimating component and determining component to perform the respective executing and identifying, resulting in identification of an inferred best matching neuron to the inference sample quantum state.

9. The system of claim 1, further comprising:
an encoding component that encodes the set of quantum data as quantum states at the neural network employing quantum feature mapping.

10. The system of claim 1, wherein the quantum data is obtained from quantum simulation or from one or more quantum transducers.

11. A computer-implemented method, comprising:
executing, by a system operatively coupled to a processor, a set of quantum circuits at a quantum processor resulting in measured outputs defining estimated inner products between a sample quantum state, of a set of quantum data, and a set of weight vectors, associated with neurons of a lattice space of a neural network; and
based on the estimated inner products, identifying, by the system, a best matching neuron of the lattice space having a closest distance, of the neurons of the lattice space, to the sample quantum state within a Hilbert space of the neural network, the Hilbert space comprising the set of quantum data and the lattice space.

12. The computer-implemented method of claim 11, further comprising:
based on the estimation of the inner product and employing a quantum kernel, updating, by the system, a subset of the weight vectors of corresponding subset of the neurons of the lattice space that have a selected proximity to the best matching neuron,
wherein the subset of adjustable weights is disposed within a selected threshold distance of the neuron.

13. The computer-implemented method of claim 12, wherein employing the quantum kernel comprises determining, by the system, gradients of kernel functions employing parameter shift rules and eigenvalues of Pauli gates corresponding to the gradients.

14. The computer-implemented method of claim 11, further comprising:
based on the estimation of the inner products resulting in transitional probabilities between the sample of quantum data and the set of weight vectors, generating, by the system, fidelities between the quantum state and other quantum states of the set of quantum data; and
employing, by the system, the fidelities in a fidelity-based metric to identify the best matching neuron.

15. The computer-implemented method of claim 11, further comprising:
executing, by the system, additional sets of quantum circuits at the quantum processor resulting in additional measured outputs defining additional estimated inner products between additional sample quantum states, of the set of quantum data, and the set of weight vectors; and
based on the additional estimated inner products, identifying, by the system, additional best matching neurons to the additional sample quantum states, and
wherein the execution and the additional execution, and the identification and the additional identification, together result in learning by the neural network of a mapping of the set of quantum data from a higher dimensional first continuous space to a lower dimensional second lattice space of neurons.

16. A computer program product facilitating a process to generate a self-organizing map based on a quantum kernel approach, the computer program product comprising a computer readable storage medium having program instructions embodied therewith, the program instructions executable by a processor to cause the processor to:
execute, by the processor, a set of quantum circuits at a quantum processor resulting in measured outputs defining estimated inner products between a sample quantum state, of a set of quantum data, and a set of weight vectors, associated with neurons of a lattice space of a neural network; and
based on the estimated inner products, identify, by the processor, a best matching neuron of the lattice space having a closest distance, of the neurons of the lattice space, to the sample quantum state within a Hilbert space of the neural network, the Hilbert space comprising the set of quantum data and the lattice space.

17. The computer program product of claim 16, wherein the program instructions are further executable by the processor to cause the processor to:
based on the estimation of the inner product and employing a quantum kernel, update, by the processor, a subset of the weight vectors of corresponding subset of the neurons of the lattice space that have a selected proximity to the best matching neuron,
wherein the subset of adjustable weights is disposed within a selected threshold distance of the neuron.

18. The computer program product of claim 17, wherein the program instructions for employing the quantum kernel are further executable by the processor to cause the processor to:
determine, by the processor, gradients of kernel functions employing parameter shift rules and eigenvalues of Pauli gates corresponding to the gradients.

19. The computer program product of claim 16, wherein the program instructions are further executable by the processor to cause the processor to:
based on the estimation of the inner products resulting in transitional probabilities between the sample of quantum data and the set of weight vectors, generate, by the processor, fidelities between the quantum state and other quantum states of the set of quantum data; and
employ, the by the processor, the fidelities in a fidelity-based metric to identify the best matching neuron.

20. The computer program product of claim 16,
wherein the Hilbert space comprises a first input layer comprising a first set of neurons having the sample quantum state and other quantum states of the set of quantum data mapped to the first set of neurons, and
wherein the Hilbert space further comprises a second output layer comprising the neurons of the lattice space.
